(19) United States
(12) Patent Application Publication
(10) Pub. No.: US 2008/0046241 A1
(43) Pub. Date: Feb. 21, 2008

(54) Method and system for detecting speaker change in a voice transaction

(76) Inventors: Andrew Osburn, Nova Scotia (CA); Jeremy Bernard, Nova Scotia (CA); Mark Boyle, Nova Scotia (CA)

Correspondence Address: PEARNE & GORDON LLP, 1801 EAST 9TH STREET, SUITE 1200, CLEVELAND, OH, 44114-3108, US

(21) Appl. No.: 11/708,191

(22) Filed: Feb. 20, 2007

(30) Foreign Application Priority Data
Feb. 20, 2006 (CA) 2,536,976

(51) Int. Cl. G10L 15/00

(52) U.S. Cl. 704/250; 704/E15.001

(57) ABSTRACT

Method and System for detecting speaker change in a voice transaction is provided. The system analyzes a portion of speech in a speech stream and determines a speech feature set. The system then detects a feature change and determines speaker change.

### FIELD OF INVENTION

The present invention relates to signal processing technology and more particularly to a method and system for processing speech signals in a voice transaction.

### BACKGROUND OF THE INVENTION

There are many circumstances in voice-based transactions where it is desirable to know if a speaker has changed during the transaction. This is particularly relevant in the justice/corrections market. Corrections facilities provide inmates with the privilege of making outbound telephone calls to an Approved Caller List (ACL). Each inmate provides a list of telephone numbers (e.g., telephone numbers for friends and family) which is reviewed and approved by corrections staff. When an inmate makes an outbound call, the dialed number is checked against the individual ACL in order to ensure the call is being made to an approved number. However, the call recipient may attempt to transfer the call to another unapproved number, or to hand the telephone to an unapproved speaker.

The detection of a call transfer during an inmate's outbound telephone call has been addressed in the past through several techniques related to detecting Public Switched Telephone Network (PSTN) signalling. When a user wishes to transfer a call on the PSTN a signal is sent to the telephone switch to request the call transfer (e.g., switch-hook flash). It is possible to use digital signal processing (DSP) techniques to detect these call transfer signals and thereby identify when a call transfer has been made.

The detection of call transfer through the conventional DSP methods is subject to error since noise, either network or man-made, can mask the signals and defeat the detection process. Further, these processes cannot identify situations where a change of speaker occurs without an associated call transfer.

### SUMMARY OF THE INVENTION

It is an object of the invention to provide a method and system that obviates or mitigates at least one of the disadvantages of existing systems.

In according with an aspect of the present invention there is provided a method of processing a speech stream in a voice transaction. The method includes analyzing a first portion of speech in a speech stream to determine a first set of speech features, storing the first set of speech features, analyzing a second portion of speech in the speech stream to determine a second set of speech features, comparing the first set of speech features with the second set of speech features, and signaling, based on the result of the comparison, speaker change to a monitoring system.

In according with another aspect of the present invention there is provided a method of processing a speech stream in a voice transaction. The method includes continuously monitoring an incoming speech stream during a voice transaction. The monitoring includes analyzing one or more than one speech feature associated with a speech sample in the speech stream, and detecting a feature change based on comparing the one or more than one speech feature associated with the speech sample to one or more than one speech feature associated with one or more than one preceding speech sample in the speech stream. The method includes determining speaker change in dependence upon the detection.

In according with a further aspect of the present invention there is provided a system for processing a speech stream in a voice transaction. The system includes an extraction module for extracting a feature set for each portion of speech in a speech stream in a continuous basis, an analyzer for analyzing the feature set for a portion of speech in the speech stream to determine a speech feature for the portion of speech in the continuous basis, and a decision module for determining speaker change in dependence upon comparing a first speech feature for a first portion of speech in the speech stream with a second speech feature for a second portion of speech in the speech stream.

### BRIEF DESCRIPTION OF THE DRAWINGS

These and other features of the invention will become more apparent from the following description in which reference is made to the appended drawings wherein:

FIG. 1 is a diagram illustrating a speaker change detection system in accordance with an embodiment of the present invention;

FIG. 2 is a diagram illustrating an example of speech processing using the system of FIG. 1;

FIG. 3 is a diagram illustrating an example of a pre-processing module of FIG. 1;

FIG. 4 is a diagram illustrating an example of feature extraction of the system of FIG. 1;

FIG. 5 is a diagram illustrating an example of dynamic model using the system of FIG. 1;

FIG. 6 is a flowchart illustrating an example of a method of detecting a speaker change in accordance with an embodiment of the present invention; and

FIG. 7 is a diagram illustrating an example of a system for a voice transaction having the system of FIG. 1.

### DETAILED DESCRIPTION OF THE PREFERRED EMBODIMENT(S)

Embodiments of the present invention are described using a speech capture device, speech pre-processing algorithms, speech digital signal processing, speech analysis algorithms, gender/language analysis algorithms, speaker modeling algorithms, speaker change detection algorithms, and speaker change detection decision matrix (decision making algorithms).

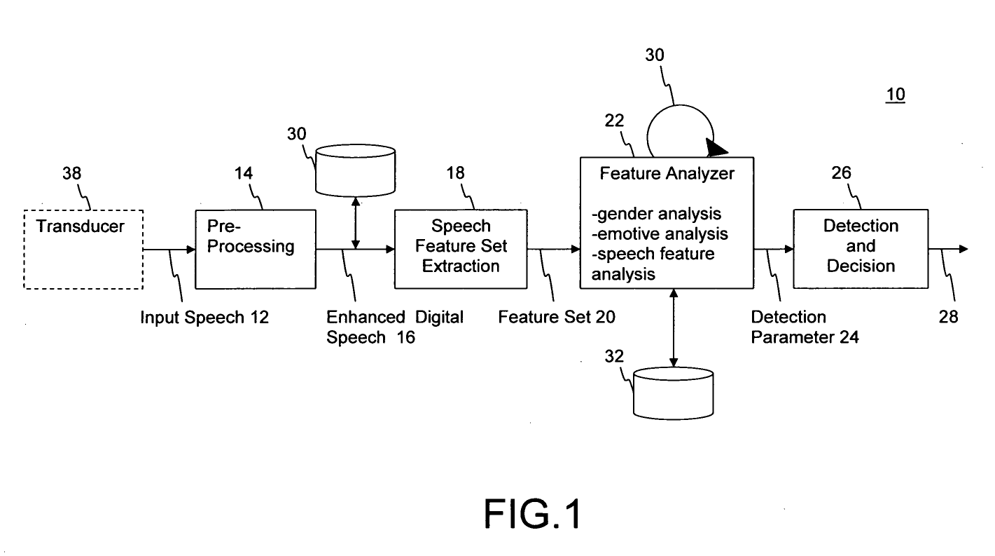

FIG. 1 illustrates a speaker change detection system in accordance with an embodiment of the present invention. The speaker change detection system 10 of FIG. 1 monitors input speech stream during a transaction, extracts and analyses one or more features of the speech, and identifies when the one or more features change substantially, thereby permitting a decision to be made that indicates speaker change.

The speaker change detection system 10 automatically completes the process of detecting speaker change using speech signal processing algorithms/mechanism. Using the speaker change detection system 10, the speaker change is detected in a continuous manner during an on-going voice transaction. The speaker change detection system 10 operates in a completely transparent manner so that the speakers are unaware of the monitoring and detection process.

The speaker change detection system 10 includes a pre-processing module 12 for processing input speech 12, a speech feature set extraction module 18 for extracting a feature set 20 of a digital speech output 16 from the pre-processing module 12, a feature analyzer 22 for analyzing the feature set 20 output from the feature analyzer 22 and outputting one or more detection parameters 24, and a detection and decision module 26 for determining, based on the one or more detection parameters 24, whether a speaker has changed and providing its decision 28.

The detection and decision module 26 uses decision parameters to determine speaker change. The decision parameters are system configurable parameters that set a threshold for permitting a decision to be made specific to the considered feature. The decision parameters include a distance measure, a consistency measure or a combination thereof.

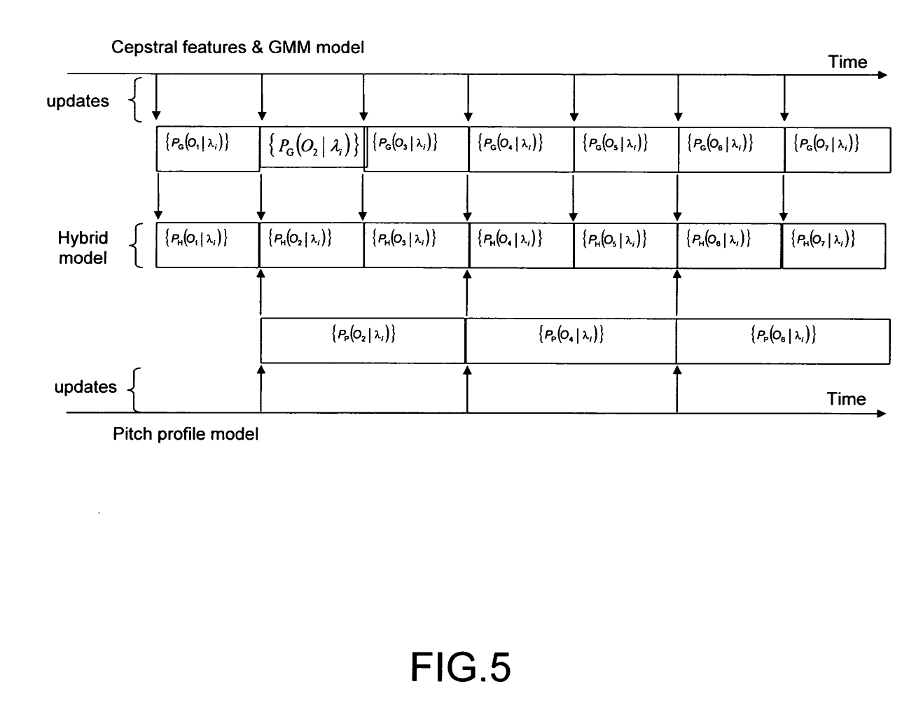

The distance measure is a numeric parameter that is set at system run-time that specifies how close a new voiced sample must be to the reference voice template in order to result in a ‘match decision’ versus a ‘no-match decision’ (e.g., FIG. 5).

The consistency measure is a numeric parameter that is set at system run-time that specifies how consistent a new voiced sample must be to the reference voice template. Consistency is a relative term that includes the characteristics of prosody, pitch, context, and discourse structure.

The speaker change detection system 10 operates in any electronic voice communications network or system including, but not limited to, the Public Switched Telephone Network (PSTN), Mobile Phone Networks, Mobile Trunk Radio Networks, Voice over IP (VoIP), and Internet/Web based voice communication services. Audio (e.g., input 12) may be received in a digital format, such as PCM, WAV and ADPCM.

In one example, one or more elements of the system 10 are implemented in a general-purpose computer coupled to a network with appropriate one or more transducers 38. The transducer 38 is any voice capture device for converting an analog mechanical wave associated with speech to digital electronic signals. The transducers may be, but not limited to, telephones, mobile phones, or microphones. In a further example, one or more elements of the system 10 are implemented using programmable DSP technology coupled to a network with appropriate one or more transducers 38. In the description, the terms “transducer”, “voice capture device”, and “speech capture device” may be used interchangeably. In another example, the pre-processing module 14 includes the one or more transducers.

In one example, the incoming input speech 12 is an analog speech stream, and the pre-processing module 14 includes an analog to digital (A/D) converter for converting the analog speech stream signal to a digital speech signal. In another example, the incoming input speech 12 is a digitally encoded version of the analogue speech stream (e.g. PCM, or ADPCM).

An initial step involves gathering, at specified intervals, samples of speech having a specified length. These samples are known as speech segments. By regularly feeding the speaker change detection system 10 with speech segments, the system 10 provides a decision on a granular level sufficient to make a short-term decision. The selection of the duration of these speech segments affects the system performance (e.g., accuracy of speaker change detection). A small speech segment results in a lower confidence score if the segments become short, and provides a more frequent verification decision output. A longer speech segment provides more accurate determination of speaker change, and provides a less frequent verification decision output (higher latency). There is a trade-off between accuracy and frequency of verification decision. The verification decision is the result of the system ‘match’ or ‘no-match’ logic based upon the system configured decision parameters, the new voiced sample, and the closeness of match to the stored voice template. The segment duration of 5 seconds has been shown to give adequate results in many situations, but other durations may be suitable depending on the application of the system.

In an example, the pre-processing module 14 includes a sampling module for sampling speech stream to create a speech segment (e.g., input speech 12) with a predefined duration. In a further example, the segment duration of speech is changeable, and is provided to the pre-processing module 14 as a duration change request.

In a further example, overlapping of speech segments is used so that the sample interval is reduced. In a further example, the pre-processing module 14 may include a sampling module for creating speech segments so as to overlap each other. In a further example, a window of the overlapping is changeable, and is provided to the pre-processing module 14 as a window change request. Overlapping speech segments alleviate the trade-off between accuracy and frequency of speaker change decision. In a further example, the overlapping of speech signals may be used as a default condition, and may be switched to non-overlapping process.

The feature set extraction 18 produces the feature set 20 based on aggregated results from the pre-processing 14. The outputs from the pre-processing module 14 are recorded and aggregated in a memory 30.

The feature analyzer 22 continuously analyzes features of the feature set 20 until the system detects speaker change, and may execute several cycles 30, each cycle focusing on one aspect of the features. The feature analyzer 22 may implement, for example, gender analysis, emotive analysis module, and speech feature analysis. The speech features analyzed at the analyzer 22 may be aggregated in a memory 32. The speaker change detection system 10 is capable of detecting speaker change based upon gender detection. The speaker change detection system 10 is capable of detecting speaker change based upon a change in the language spoken. The system 10 is capable of detecting speaker change based upon a change in speech prosody.

Based on the decision parameters, the detection and decision module 26 compares the one or more detection parameters 24 with those derived from previous feature sets extracted from the same analogue input stream. The detection and decision module 26 provides its determination 28 of any change to a monitor facility (not shown). The monitoring facility may have a visual indicator, a sound indicator, any other indicators or combinations thereof, which operate in dependence upon the determination signal 28.

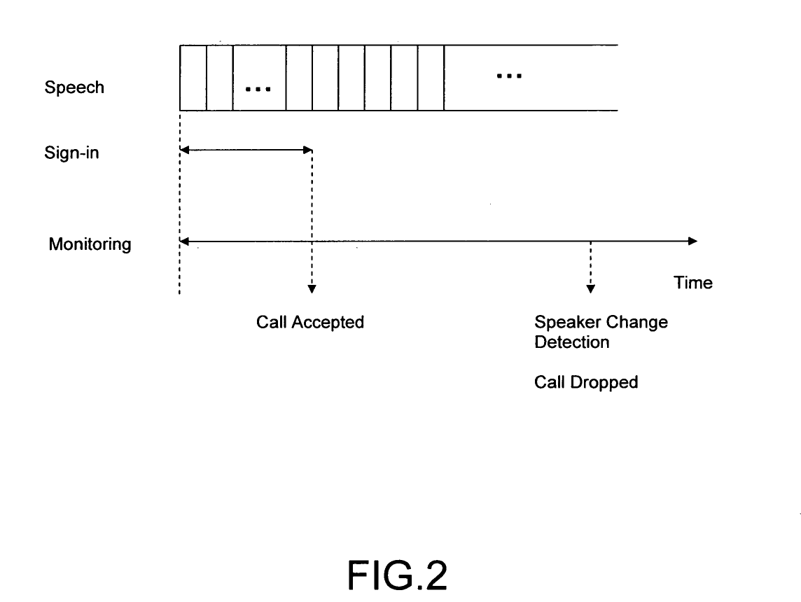

The speech processing using the system 10 includes, for example, enrolment, sign in (connection approval), and monitoring voice transaction processes. During the enrolment, a speaker model is built for each person who is allowed to be connected via a voice transaction. In operation, a call for a person A is accepted if the speech features of that person A match any speaker models. At the same time, the system 10 continuously monitors the incoming speech, as shown in FIG. 2. The feature set can be used at sign-in and then it can also be used during the monitoring phase to determine if the speaker has changed. The system 10 creates a dynamic model to determine speaker change, as described below.

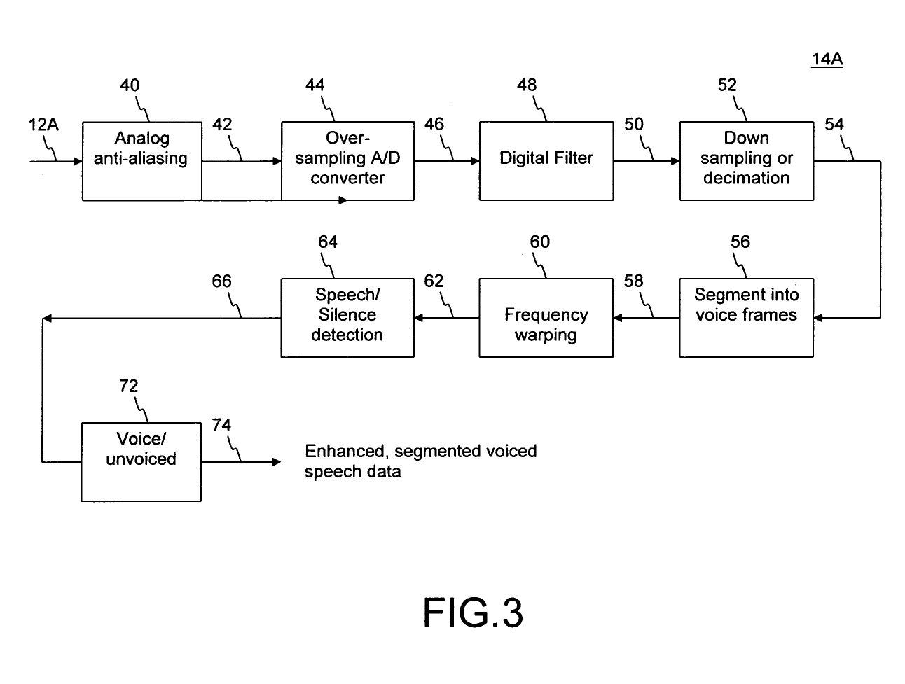

The pre-processing module 14 of FIG. 1 is described in detail. Referring to FIG. 3, the pre-processing module 14 converts the input 12, which may contain any noise or be distorted, into clean, digitized speech suitable for the feature extraction 18. FIG. 3 illustrates an example of the pre-processing module 14 of FIG. 1. In FIG. 3, an operation flow for a single cycle of the analysis is illustrated. The pre-processing module 14A of FIG. 3 receives an analogue input speech stream 12A. The analog input speech stream 12A is filtered at an analog anti-aliasing module 40 so as to alleviate the effect of aliasing in subsequent conversions. The anti-aliased speech stream 42 is then passed to an over-sampling A/D converter 44 to produce a PCM version of the speech stream 46. Further digital filtering is performed to the speech stream 46 by a digital filter 48. A filtered stream 50 from the digital filter 48 is down-sampled or decimated at a module 52. In addition to providing band-limiting to avoid aliasing, this filtering also provides a degree of high-frequency noise removal. Oversampling, i.e. the sampling at rates are much higher than the Nyquist frequency, allows high performance digital filtering in the subsequent stage. The resultant decimated stream 54 is segmented into voice frames 58 at a frame module 56.

The frames 58 output from the frame module 56 are frequency warped at a module 60. The output 62 from the module 60 is then analyzed at a speech-silence detector 64 to detect speech data 66 and silence. The output 62 is a voice stream still when it is considered that each frame can be aggregated contiguously to form the full voice sample. At this point the output 62 is processed speech broken into very short frames.

The speech/silence detector 64 contains one or more models of the background noise for speech enhancement. The speech/silence detection module 64 detects any silence, removes it, and then passes on speech frames that contain only speech and no silence.

The processed speech 66 is further analyzed at a voice/unvoiced detector 72 to detect voiced sound 70 so that unvoiced sounds may be ignored. The voice/unvoiced detector 72 outputs an enhanced and segmented voiced speech 74 which is suitable for feature extraction.

In one example, the voice/unvoiced detector 72 selectively outputs a voiced portion of the processed speech 66, and thus the speaker change detection is performed exclusively on voiced speech data, as unvoiced data is much more random and may cause problems to the classifier (i.e., Gaussian Mixture Model: GMM). In another example, the system 10 of FIG. 1 selectively operates the voiced/unvoiced detector 72 based on a control signal.

In one application, a high performance digital filter (e.g., 48 of FIG. 3) provides a clearly defined signal pass-band, and the filtered, over-sampled data are decimated (e.g., 52 of FIG. 3) to allow more efficient processing in subsequent stages. The resultant digitized, filtered voice stream is segmented into, for example, 10 to 20 ms voice frames which overlap by 50% (e.g., 56 of FIG. 3). This frame size is conventionally accepted as the largest window in which stationarity can be assumed. Briefly, “stationarity” means that the statistical properties of the sample do not change significantly over time. The frames are then warped to ensure that all frequencies are in a specified pass-band (e.g., 60 of FIG. 3). Frequency warping compensates for mismatches in the pass-band of the speech samples.

The frequency-warped data is further segmented into portions, those that contain speech, and those that can be assumed to be silence or rather speaker pauses (e.g., 64 of FIG. 3). This process ensures that feature extraction (18 of FIG. 1) only considers valid speech data, and also allows the construction of models of the background noise used in speech enhancement (e.g., 64 of FIG. 3).

The speech feature set extraction module 18 of FIG. 1 is described in detail. The feature set extraction module 18 processes the speech waveform in such a way as to retain information that is used in discriminating between different speakers, and eliminate any information which is not relevant to speaker change detection.

There are two main sources of speaker-specific characteristics of speech: physical and learned. The physical characteristics of the speech include, for example, vocal tract shape and the fundamental frequency associated with the opening and closing of the vocal folds (known as pitch). Other physiological speaker-dependent features include, for example, vital capacity, maximum phonation time, phonation quotient, and glottal airflow. The learned characteristics of speech include speaking rate, prosodic effects, and dialect. In one example, the learned characteristics of speech are captured spectrally as a systematic shift in formant frequencies. Phonation is the vibration of vocal folds modified by the resonance of the vocal tract. The averaged phonation air flow or Phonation Quotient (PQ)=Vital Capacity (ml)/maximum phonation time (MPT). Prosodic means relating to the rhythmic aspect of language or to the suprasegmental phonemes of pitch and stress and juncture and nasalization and voicing. Any of combinations of the physical characteristics of speech and the learned characteristics of speech may be used for speaker change detection.

Although there are no features that exclusively (and unambiguously) convey speaker identity in the speech signal, the speech spectrum shape encodes (conveys) information about the speaker's vocal tract shape via resonant frequencies (formants) and about glottal source via pitch harmonics. As a result, in one example, spectral-based features are used at the feature analyzer 22 to assist speaker identification which in turn permits speaker change detection. Short-term analysis is used to establish windows or frames of data that may be considered to be reasonably stationary (stationarity). In one example, 20 ms windows are placed every 10 ms. Other window sizes and placements may be chosen, depending on the application and experience.

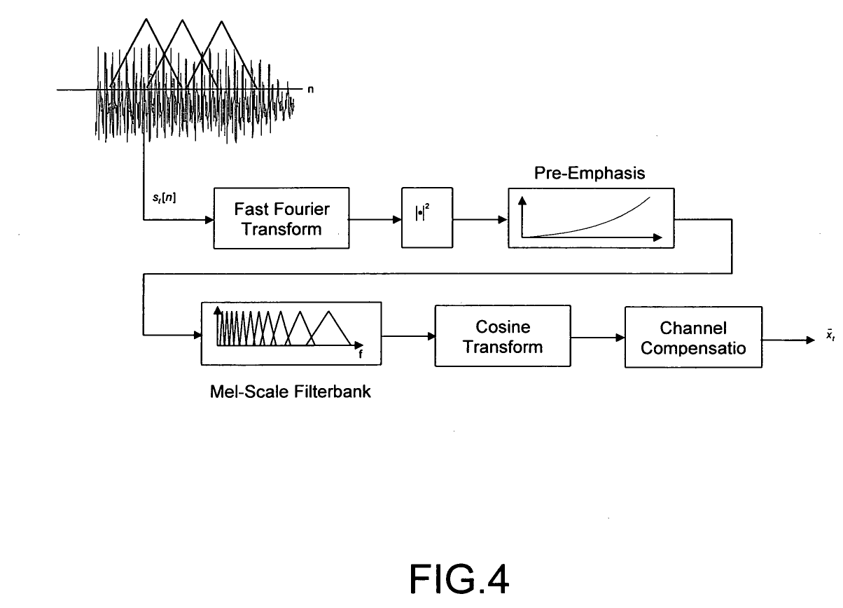

In one example, in the speech feature set extraction, a sequence of magnitude spectra is computed using, for example, either linear predictive coding (LPC) (all-pole) or Fast Fourier Transform (FFT) analysis. The magnitude spectra are then converted to cepstral features after passing through a mel-frequency filterbank. The Mel-Frequency Cepstrum Coefficients (MFCC) method analyzes how the Fourier transform extracts frequency components of a signal in the time-domain. The “mel” is a subjective measure of pitch based upon a signal of 1000 Hz being defined as “1000 mels” where a perceived frequency twice as high is defined as 2000 mels and half as high as 500 mels. It has been shown that for many speaker identification and verification applications those using cepstral features outperform all others. Further, it has been shown that LPC-based spectral representations may be affected by noise, and that FFT-based cepstral features are the most robust in the context of noisy speech. The exemplary method of capturing the cepstral features is illustrated in FIG. 4.

In another example, the characteristics of feature sets may include high speaker discrimination power, high inter-speaker variability, and low intra-speaker variability. These are generalized characteristics that describe speech features useful in determining variability in individual speakers. They may be used when algorithms permit speaker identification and hence speaker change.

During enrolment (training), the normalized feature set is used to build a speaker model. In operation, the feature set is compared with each model to determine the best match (e.g., for sign in of FIG. 2). Desirable attributes of a speaker model are:
A theoretical foundation so that one can comprehend model behaviour, and develop an analytical instead of a heuristic approach to extensions and improvements;
The ability to generalize to new data, without overfitting the enrolment data;
Efficiency in terms of representation size and computation.

Gaussian Mixture Model (GMM) based approaches are used in text-independent speaker identification. A Gaussian mixture density is a weighted sum of M component densities:

$$p ( {x}^{->} \vert λ ) = {\sum }_{i = 1}^{M} {p}_{i} {b}_{i} ( {x}^{->} ) \qquad ( 1 )$$

where \vec{x} is a D-dimensional vector, bᵢ(\vec{x}), i=1, . . . , M are the component densities, and pᵢ, i=1, . . . , M are the mixture weights. Each component density is a D-variate Gaussian function of the form:

$${b}_{i} ( {x}^{->} ) = \frac{1}{{( 2 π )}^{D / 2} {\vert {Σ}_{i} \vert}^{1 / 2}} exp \{ - \frac{1}{2} {( {x}^{->} - {{μ}^{->}}_{i} )}^{′} {\sum }_{i}^{- 1} ( {x}^{->} - {{μ}^{->}}_{i} ) \} \qquad ( 2 )$$

with mean vector \vec{μ}ᵢ and covariance matrix Σᵢ.

The complete Gaussian mixture density is parameterized by the mean vectors, covariance matrices and mixture weights. These parameters are collectively represented by the notation

λ={pᵢ, \vec{μ}ᵢ, Σᵢ}, i=1, . . . , M, (3)

For speaker identification, each speaker is represented by a GMM and is referred to by his/her model, λ. The specific form of the covariance matrix can have important ramifications in speaker identification performance.

There are two principal motivations for using Gaussian mixture densities as a representation of speaker identity. The first is the intuitive notion that the component densities of a multi-modal density may model some underlying set of acoustic classes. It is reasonable to assume that the acoustic space corresponding to a speaker's voice can be characterized by a set of acoustic classes representing some broad phonetic events, such as vowels, nasals, or fricatives. These acoustic classes reflect some general speaker-dependent vocal tract configurations that can discriminate speakers. The second motivation is the empirical observation that a linear combination of Gaussian basis functions is capable of representing a large class of sample distributions. One of the powerful attributes of the GMM is its ability to form smooth approximations to arbitrarily-shaped densities.

The goal of training a GMM speaker model is to estimate the parameters of the GMM, λ, which in some sense best matches the distribution of the training feature vectors. There are several techniques available for estimating the parameters of a GMM, including maximum-likelihood (ML) estimation.

The aim of ML estimation is to find the model parameters which maximize the likelihood of the GMM, given the training data. For a sequence of T training vectors X={\vec{x}₁, . . . , \vec{x}_{T}}, the GMM likelihood can be written as

$$p ( {x}^{->} \vert λ ) = {\prod }_{t = 1}^{T} p ( {{x}^{->}}_{t} \vert λ ) . \qquad ( 4 )$$

This expression is a nonlinear function of the parameters λ and direct maximization is not possible. The ML parameter estimates can be obtained iteratively, however, using a special case of the expectation-maximization (EM) algorithm. Two factors in training a GMM speaker model are selecting the order M of the mixture and initializing the model parameters prior to the EM algorithm. There are no robust theoretical means of determining these selections, so they are experimentally determined for a given task.

The feature analyzer 22 and the detection and decision module 26 of FIG. 1 are described in detail. The speaker change detection system 10 of FIG. 1 detects a change of a feature, rather than to verify the speaker, and make a decision on whether a speaker is changed.

The analysis and decision process are structured such that the speech features from the analyzer 22 of FIG. 1 are aggregated and matched against features monitored and captured during the preceding part of the transaction in an ongoing, continuous fashion (monitoring process of FIG. 2). The speech features are monitored for a substantial change that indicates potential speaker change.

In an example, the feature analyzer 22 includes one or more modules for analyzing and monitoring one or more characteristic speech features for speaker change detection. For example, the one or more characteristic speech features include gender, prosody, context and discourse structure, paralinguistic features or combinations thereof.

Gender: Gender vocal effect detection and classification is performed by analyzing and measuring levels and variations in pitch.

Prosody: Prosody includes the pattern of stress and intonation in a person's speech. This includes vocal effects such as variations in pitch, volume, duration, and tempo. Prosody in voice holds the potential for determination of conveyed emotion. Prosodic information may be used with other techniques, such as Gaussian Mixture Model (GMM).

Context and discourse structure: Context and discourse structure give consideration to the overall meaning of a sequence of words rather than looking at specific words in isolation. In one example, the system 10, while not identifying the actual words, determines potential speaker change by identifying variations in repeated word sequences (or perhaps voiced element sequences).

Paralinguistic Features: Paralinguistic Features are of two types. The first is voice quality that reflects different voice modes such as whisper, falsetto, and huskiness, among others. The second is voice qualifications that include non-verbal cues such as laugh, cry, tremor, and jitter.

In one example, it may look for a sudden change in speaker characteristic features. For example, if four segments have been analyzed and have features that match each other at an 80% confidence (confidence level) and the next three are verified with a confidence of 60% (or vice versa), this may be interpreted as a change in speakers. The confidence level is not firm but rather determined through empirical testing in the environment of use. The confidence level is a user-defined parameter that may vary based upon the application. The confidence level may be a variable and is provided to the system 10 of FIG. 1.

The detection and decision module 26 includes one or more speaker change detection algorithms. The speaker change detection algorithms are based upon a system using short-term features (e.g., the mel-scale cepstrum with a GMM classifier) and longer-term features (e.g., pitch contours with distance). Assume that the output of each classifier (expert) can produce a continuous score that can be interpreted as a likelihood measure (e.g., a GMM or a distance measure).

The cepstral features are computed over a shorter time period (individual frames) than the pitch contour features (which require multiple frames). As the time available for analysis increases, the reliability of the likelihood measure derived from each classifier will improve, as the statistical model will have more data for estimation. Assume that O₁ are the speech data contained in frame 1, O₂ the data in frames 1 and 2, Oⱼ the data in frames 1, 2, . . . j.

For the i^{th} speaker, the output of the GMM speaker model using the data Oⱼ can be expressed as P_{G}(Oⱼ|λᵢ). The collection of speaker models for K speakers is {P_{G}(Oⱼ|λᵢ)}, i=1, . . . , K. This is with every frame, as illustrated in FIG. 5 where a mixture of score-based experts operates with different analysis window lengths for speaker change detection.

Consider now the use of pitch profile information. For simplicity, consider that the amount of data required for pitch analysis is twice that of cepstral analysis (two frames). Usually this suprasegmental technique would require much more data, but this simplifies the argument without loss of generality. Following these assumptions, consider that the first likelihood estimates from the pitch profile analysis become available using the data O₂, and follow every other frame producing Pₚ(O₂|λᵢ) Pₚ(O₄|λᵢ) Pₚ(O₆|λᵢ), . . . , as illustrated in FIG. 5. Individually, the cepstral and pitch analyses will improve in reliability as more data becomes available. Consider that the scores from each expert may be mixed, however, to yield an estimate that is presumably more reliable than each individual expert.

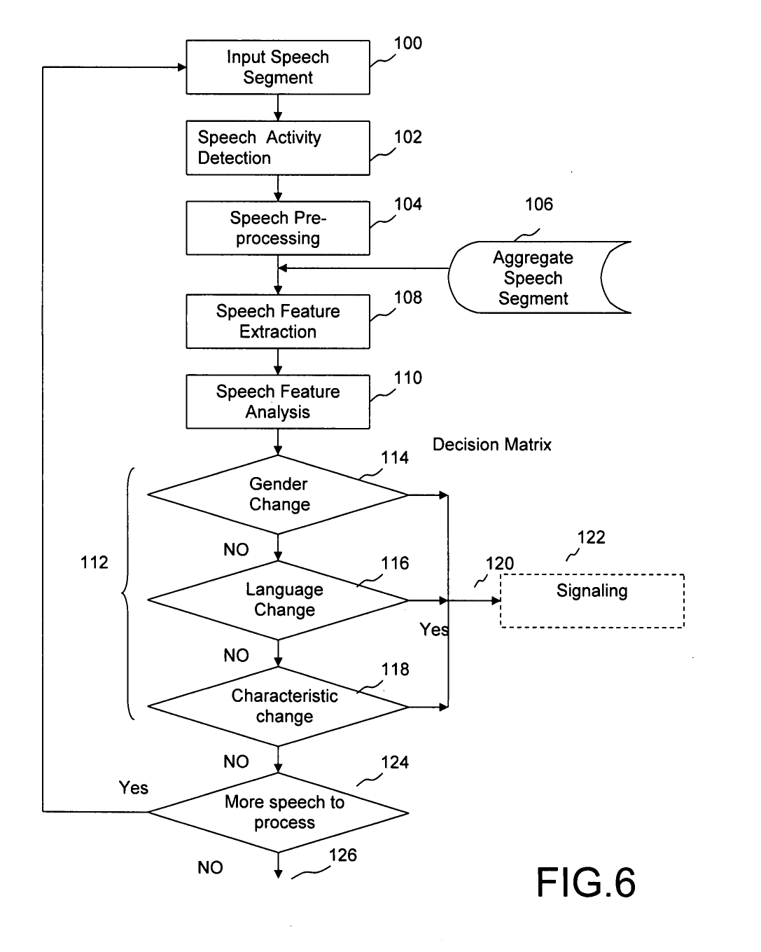

FIG. 6 illustrates an example of a method of detecting speaker change in accordance with an embodiment of the present invention. In FIG. 6, a speech segment is input (step 100), and any speech activity is detected (step 102) by Speech Activity Detection (SAD) before preprocessing takes place (step 104).

The Speech Activity Detection (SAD) is provided to distinguish between speech and various types of acoustic noise. The SAD is used in similar fashion as silence detection to analyze a sample of speech, detect noise and silence which degrade the quality of the speech, and then remove the un-voiced speech and silence.

The speech segment is pre-processed (step 104) in a manner same or similar to that of the pre-processing module 14 of FIG. 1. Speech segments are aggregated (step 106). Speech features are extracted (step 108). The extracted one or more features are analyzed (step 110). A detection and decision (step 112) includes a decision matrix and is performed using any of the specific features' changes, such as gender change 114, language change 116, characteristic change 118, to detect and determine speaker change 120. The speaker change 120 may be signaled (step 122) to a monitoring system.

The gender change of step 114 is a step in the process which determines if a gender identified from a portion of speech is different from that identified from another portion of speech.

The language change of step 116 is a step in the process which determines if the speaker has changed the spoken language, e.g., from French to English etc.

The characteristic change of step 118 can refer to the result of the decision process resulting from the process of the detection and decision module 26 of FIG. 1

At the end of segment analysis, it is determined whether there is a next segment or whether a further detection is performed (step 124). If yes, it goes step 100, otherwise the process ends (step 126).

In FIG. 6, the step 116 is implemented after the step 114, and the step 118 is implemented after the step 116. However, the order of the steps 114, 116 and 118 may be changed. In a further example, the steps 114, 116, and 118 may be implemented in parallel.

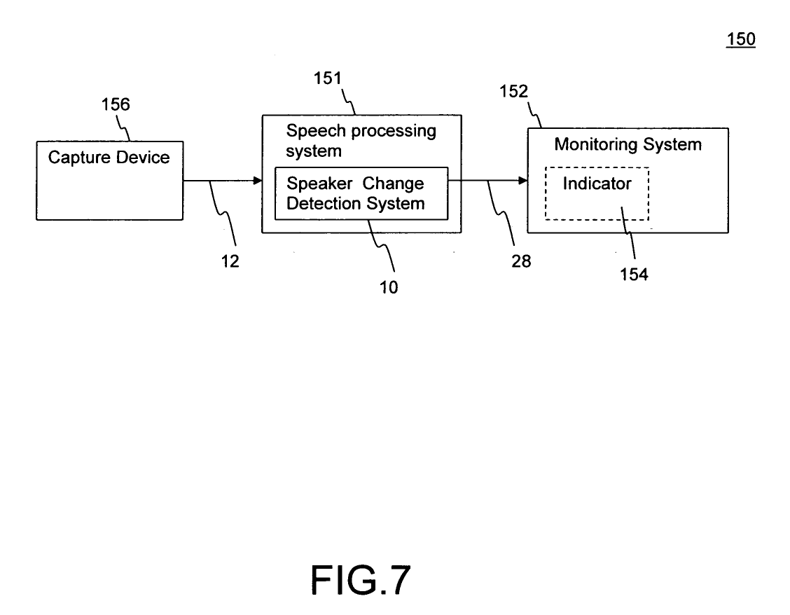

FIG. 7 illustrates a system for voice transaction. In the system 150 of FIG. 7, a speech processing system 151 having the speaker change detection system 10 communicates with a monitoring system 152 for monitoring a voice transaction through a wired network, a wireless network or a combination thereof. The monitoring system 152 may include an indicator 154 operating in dependence upon the decision signal 28 from the speaker change detection system 10. The monitoring system 152 may communicate with a system for preventing the voice transaction.

The speech processing system 151 having the speaker change detection system 10 builds a speaker model for enrolment, and also builds a dynamic model on continuous basis during a voice transaction, as described above.

In FIG. 7, a speech capture device 156 for capturing speech stream is provided to the speaker change detection system 10. The speech capture device 156 may capture speech stream from an external analog or digital network (e.g., public telephone network). The speech capture device 156 may include a sampler for providing the input speech 12. As described above, the speech capture device 156 or the sampling module may be included in the pre-processing module 14 of FIG. 1. The speech capture device 156 includes one or more transducers. The transducer converts human speech from an analog mechanical wave to a digital electronic signal. The transducers may be, for example, but not limited to, telephones, mobile phones, microphones etc.

The embodiments of the invention are suitable for use in monitoring calls in the justice/corrections market, among others, to detect unauthorised conversations. The justice/corrections environments may include, for example, a prison corrections environment where it can be used to detect speaker changes during inmate's outbound telephone calls. It will be appreciated by one of ordinary skill in the art that the embodiments described above are applicable to other environments and situations.

The signal processing and the speaker change detection in accordance with the embodiments of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements, which may be embedded in a carrier wave may be transmitted via a communication network. Such a computer readable memory and a computer data signal and/or its carrier are also within the scope of the present invention, as well as the hardware, software and the combination thereof.

One or more currently preferred embodiments have been described by way of example. It will be apparent to persons skilled in the art that a number of variations and modifications can be made without departing from the scope of the invention as defined in the claims.

What is claimed is:

1. A method of processing a speech stream in a voice transaction, the method comprising the steps of:
analyzing a first portion of speech in a speech stream to determine a first set of speech features;
storing the first set of speech features;
analyzing a second portion of speech in the speech stream to determine a second set of speech features;
comparing the first set of speech features with the second set of speech features; and
signaling, based on the result of the comparison, speaker change to a monitoring system.

2. The method as claimed in claim 1, wherein the method continuously monitors the speech stream, comprising:
storing the second set of speech features;
analyzing a third portion of speech in the speech stream to determine a third set of speech features; and
comparing the second set of speech features with the third set of speech features.

3. The method as claimed in claim 1, wherein the first and second sets of speech features include at least one of gender, prosody, context and discourse structure, paralinguistic features, and combinations thereof.

4. The method as claimed in claim 1, further comprising sampling the speech stream to provide the first and second speech portions, each having a duration.

5. The method as claimed in claim 4, further comprising changing the duration in dependence upon a change request.

6. The method as claimed in claim 4, wherein the step of sampling is implemented so as to overlap the first portion of speech and the second portion of speech.

7. The method as claimed in claim 1, further comprising capturing the speech stream from a public telephone network.

8. The method as claimed in claim 1, wherein the speech stream is a digitally encoded version of an analogue speech stream.

9. The method as claimed in claim 1, wherein at least one of the steps of storing and the steps of analyzing and the step of singaling is carried out in a suitably programmed general purpose computer having a transducer to permit interaction with the speech stream and with the monitoring system.

10. The method as claimed in claim 1, wherein at least one of the steps of storing and the steps of analyzing and the step of singalling is carried out in a programmed digital signal processor having a transducer to permit interaction with the speech stream and with the monitoring system.

11. The method as claimed in claim 1, further comprising the step of:
discarding unvoiced portion in the first portion; and
discarding unvoiced portion in the second portion.

12. The method as claimed in claim 1, further comprising the steps of:
defining stationarity of the first portion of speech; and
defining stationarity of the first portion of speech.

13. The method as claimed in claim 4, wherein the duration is about 5 seconds.

14. A method of processing a speech stream in a voice transaction, the method comprising the steps of:
continuously monitoring incoming speech stream during the voice transaction, including:
analyzing one or more than one speech feature associated with a speech sample in the speech stream, and
detecting a feature change in dependence upon comparing the one or more than one speech feature associated with the speech sample to one or more than one speech feature associated with one or more than one preceding speech sample in the speech stream, and
determining speaker change in dependence upon the detection.

15. A method as claimed in claim 14, further comprising sampling the speech stream to continuously provide the speech sample.

16. A method as claimed in claim 15, wherein the step of sampling includes sampling the speech stream so that consecutive speech samples are overlapped.

17. A method as claimed in claim 16, wherein the step of sampling includes changing a window of the overlapping in dependence upon a change request.

18. A method as claimed in claim 14, wherein the step of analyzing includes analyzing the one or more than one speech feature based on aggregated speech samples having the speech sample.

19. A method as claimed in claim 18, wherein the step of analyzing includes implementing spectral-based feature analysis.

20. A method as claimed in claim 14, wherein the step of determining includes making a decision of the speaker change in dependence upon a confidential level.

21. A method as claimed in claim 14, further comprising implementing noise reduction operation to the speech sample prior to the step of analyzing.

22. A method as claimed in claim 15, further comprising discarding unvoiced data prior to the step of analyzing.

23. A method of claim 14, further comprising signaling the determination to a monitoring system.

24. A method as claimed in claim 14, wherein the step of analyzing comprises building a dynamic model based on a continuous basis, which is associated with the one or more than one speech feature.

25. A method as claimed in claim 14, further comprising approving the voice transaction based on at least one speech model prior to the step of monitoring.

26. A system processing a speech stream in a voice transaction, the system comprising:
an extraction module for extracting a feature set for each portion of speech in a speech stream in a continuous basis;
an analyzer for analyzing the feature set for a portion of speech in the speech stream to determine a speech feature for the portion of speech in the continuous basis; and
a decision module for determining speaker change in dependence upon comparing a first speech feature for a first portion of speech in the speech stream with a second speech feature for a second portion of speech in the speech stream.

27. A system as claimed in claim 26, wherein the decision module comprises a module for signalling the result of the decision to a monitoring system.
